(19) United States
(12) Patent Application Publication
(10) Pub. No.: US 2008/0095016 A1
(43) Pub. Date: Apr. 24, 2008

(54) Optical Device For Recording and Reproducing

(75) Inventors: Joris Jan Vrehen, British Virgin Islands (NL); Petrus Theodorus Jutte, British Virgin Islands (NL)

Correspondence Address: BAINWOOD HUANG & ASSOCIATES LLC, 2 CONNECTOR ROAD, WESTBOROUGH, MA, 01581, US

(73) Assignee: ARIMA DEVICES CORPORATION, Road Town, Tortola (VG)

(21) Appl. No.: 11/661,617

(22) PCT Filed: Aug. 22, 2005
(86) PCT No.: PCT/IB05/52748

§ 371 Date: Feb. 28, 2007

(30) Foreign Application Priority Data
Sep. 2, 2004 (EP) 04300572.7

(51) Int. Cl. G11B 7/135

(52) U.S. Cl. 369/112.22

(57) ABSTRACT

The invention relates to an optical device comprising a first radiation source (101) for producing a first radiation beam, a second radiation source (101) for producing a second radiation beam and means for directing the first and second radiation beams along a common optical path. Each radiation beam has an intensity distribution, a central axis and an outer envelope. The optical device further comprises, in the common optical path, means (103) for modifying the intensity distribution of the first radiation beam only. This means are designed for increasing the ratio between the intensity near the envelope and the intensity near the central axis of the first radiation beam by reducing at least the intensity of the first radiation beam near its central axis.

### FIELD OF THE INVENTION

The present invention relates to an optical device for writing to and/or reading from at least two different types of information carrier.

The present invention also relates to an optical component for use in such an optical device.

The present invention is particularly relevant for an optical disc apparatus for recording to and reading from optical discs such as CDs, DVDs or Blu-Ray Discs (BD).

### BACKGROUND OF THE INVENTION

In order to record data on and read data from an information carrier such as an optical disc, a radiation beam is used in an optical device. The information carrier comprises a recording layer, whose properties can be modified locally by applying a high-intensity radiation beam. The local changes induced in the recording layer correspond to written data and are subsequently used for reproducing the information by means of a lower-intensity radiation beam. For example, a phase change material is used as recording layer. During writing, the recording layer is altered by the high-intensity radiation beam, but the resulting information layer is not altered during reading, because a low-intensity radiation beam is used for reading.

The radiation beam is produced by a radiation source and is focused on the information layer along an optical path by means of a collimator lens and an objective lens. Along the optical path, the radiation beam has a central axis and an outer envelope. The radiation beam has an intensity distribution, which depends on the radiation source and the optical device. In known optical devices, the intensity of the beam near the central axis is greater than the intensity near the outer envelope. The ratio between the intensity near the outer envelope and the intensity near the central axis of the radiation beam is called the rim intensity.

Different types of optical scanning device have been developed recently. In order to increase the data capacity, the wavelength of the scanning beam is more and more reduced, whereas the numerical aperture of the scanning beam is more and more increased. For example, in a CD recorder, the wavelength of the scanning beam is 785 nanometers and the numerical aperture is 0.5. In a DVD recorder, the wavelength of the scanning beam is 650 nanometers and the numerical aperture is 0.65. In a BD recorder, the wavelength of the scanning beam is 405 nanometers and the numerical aperture is 0.85. It is important that a new optical scanning device is compatible with old information carriers, such that a user buying a new optical scanning device can still read his old information carriers. For example, a DVD player should be able to play DVDs and CDs.

An optical scanning device compatible with at least two different types of information carrier should not be too bulky. A solution for that consists in directing the two radiation beams of the device on a common optical path, in such a way that the same optical elements are used for the two different radiation beams. In particular, it is very interesting, in terms of cost and space, if the same collimator is used for collimating the two different radiation beams.

In order to record data on and read data from an information layer of the information carrier, a certain amount of rim intensity is required. Actually, if the rim intensity is too low, the quality of the spot formed by the beam on the information layer is bad, and the writing and reading processes are affected. The following example applies to CDs and DVDs, although it could also apply to other kinds of information carriers.

In order to scan a DVD, a certain amount of rim intensity is required. As a consequence, the numerical aperture of the collimator should be limited in order to cut the far field of the DVD radiation beam such as to increase the rim intensity. However, reduction of the numerical aperture of the collimator reduces the coupling efficiency of the CD radiation beam. Actually, the less the numerical aperture of the collimator, the less power of the CD radiation beam on disc, because a relatively large portion of the CD radiation beam is cut. This leads to the problem that when only one collimator is used for the CD and for the DVD radiation beam, it is either impossible to obtain a sufficient rim intensity of the DVD radiation beam or impossible to obtain a sufficient power of the CD beam on the information carrier.

Patent application WO02/25646 gives a solution to this problem. In this patent application, an optical element is placed on the common optical path, which acts as a lens for either the CD beam or the DVD beam only. This optical element is a diffractive structure that, for example, is transparent for the DVD radiation beam and acts as a converging lens for the CD radiation beam. This optical element is also called a holographic pre-collimator. In this example, the DVD radiation beam passes through this optical element without any modification. The CD radiation beam is concentrated by means of the holographic pre-collimator, so that a greater portion of the CD radiation beam is coupled on the collimator and thus reaches the disc. As a consequence, the coupling efficiency of the CD beam is increased, while the rim intensity of the DVD radiation beam remains unchanged, because the numerical aperture of the collimator remains unchanged.

A drawback of the solution presented in WO02/25646 is that the holographic pre-collimator uses a fine diffractive structure, which thus diffracts light. This has for consequence that light is lost, and thus the intensity of the CD radiation beam is decreased. Even if the coupling efficiency of the CD radiation beam is globally increased by means of the holographic pre-collimator, this increase is indeed relatively low.

### SUMMARY OF THE INVENTION

It is an object of the invention to provide an optical device compatible with at least two types of information carrier, in which the optical throughput for one type is increased while not reducing the rim intensity for the second type.

To this end, the invention proposes an optical device comprising a first radiation source for producing a first radiation beam, a second radiation source for producing a second radiation beam and means for directing the first and second radiation beams along a common optical path, each radiation beam having an intensity distribution, a central axis and an outer envelope, the optical device further comprising, in the common optical path, means for modifying the intensity distribution of the first radiation beam only, which are designed for increasing the ratio between the intensity near the envelope and the intensity near the central axis of the first radiation beam by reducing at least the intensity of the first radiation beam near its central axis.

According to the invention, the intensity near the central axis of the first radiation beam is reduced. The intensity near the envelope of the first radiation beam may also be reduced, but the means for modifying the intensity distribution are designed such that the ratio between the intensity near the envelope and the intensity near the central axis is increased. As a consequence, the rim intensity of the first radiation beam is increased. It is thus possible to increase the numerical aperture of the collimator without decreasing the rim intensity of the first radiation beam. For example, if the first radiation beam has a first rim intensity without the means for modifying the intensity distribution, it is possible to increase the numerical aperture of the collimator until the rim intensity of the first radiation beam is equal to the first rim intensity when the means for modifying the intensity distribution are placed on the common optical path. As a consequence of the increase of the numerical aperture of the collimator, the coupling efficiency of the second radiation beam is increased, because a larger portion of the second radiation beam passes through the collimator. As the means for modifying the intensity distribution do not modify the intensity of the second radiation beam, the optical throughput of the second radiation beam is increased.

Advantageously, the first and second radiation sources form part of one and the same laser diode. Such an optical device is relatively compact.

Preferably, the first radiation beam comprises at least a first and a second direction perpendicular to its central axis, the first radiation beam having a first intensity distribution with a first mean intensity in the first direction and a second intensity distribution with a second mean intensity in the second direction, said second mean intensity being greater than the first mean intensity, wherein the means for modifying the intensity distribution are designed for reducing the second mean intensity more strongly than the first mean intensity.

The radiation sources usually used in optical devices have a beam divergence aspect ratio greater than one. This leads to an elliptically shaped spot, which affects the writing and reading of data. In the known optical devices, this is compensated by a beam shaper which reduces the intensity in a direction where the intensity is the highest. However, such a beam shaper requires careful aligning with the collimator and the radiation source, which complicates the assembling process of the optical device.

According to this preferred embodiment, no beam shaper is required for the first radiation beam, as the means for modifying the intensity distribution are designed for compensating the beam divergence aspect ratio of the radiation source. As a consequence, the optical device is less bulky and the assembling process of the optical device is easier.

Advantageously, the means for modifying the intensity distribution comprise an optical component designed for increasing the ratio between the intensity near the envelope and the intensity near the central axis of the first radiation beam in that the first radiation beam is diffracted at least near the central axis. The means for modifying the intensity distribution comprise a diffractive structure, which is easy to design and to replicate, for example by means of a moulding process.

Preferably, the optical component has a phase structure with a duty cycle which decreases from the central axis to the outer envelope of the radiation beam. Such a phase structure is well adapted for increasing the rim intensity of radiation beams having an intensity which decreases from the central axis to the outer envelope. Moreover, as the phase depth of said phase structure is constant, the phase depth can be easily chosen in such a way that the optical component acts as a transparent plate for the second radiation beam.

Advantageously, the optical component has a periodic phase structure. In this case, the phase structure creates three orders of diffraction. As a consequence, one main spot and two satellite spots are created from the first radiation beam. These three spots can be used for the so-called 3 spots or differential push-pull tracking method. Hence, the light that is removed from the radiation beam to increase the rim intensity of the first radiation beam is used to create the two satellite spots used in the 3 spots push-pull tracking method. As a consequence, no light is lost from the first radiation beam, which means that the optical throughput of the first radiation beam is relatively high.

Preferably, the means for modifying the intensity distribution comprise a dichroic filter. Such a dichroic filter is easy to manufacture and can be easily placed in the common optical path. For example, the dichroic filter may be deposited on a glass or plastic substrate placed in the common optical path. The dichroic filter may also be deposited on one of the components of the optical device, such as the collimator. In this case, the optical device is compact, because no other optical component is added in the optical path.

The invention also relates to an optical component for modifying the intensity distribution of a first radiation beam having a first wavelength while not modifying the intensity distribution of a second radiation beam having a second, different wavelength, said optical component being designed for increasing the ratio between the intensity near the envelope and the intensity near the central axis of the first radiation beam by reducing at least the intensity of the first radiation beam near its central axis.

These and other aspects of the invention will be apparent from and will be elucidated with reference to the embodiments described hereinafter.

### BRIEF DESCRIPTION OF THE DRAWINGS

The invention will now be described in more detail by way of example with reference to the accompanying drawings, in which:

FIG. 1 shows an optical device in accordance with the invention;

FIG. 2 shows an optical component in accordance with a preferred embodiment of the invention;

FIGS. 3a and 3c show intensity distributions of the first radiation beam before and after the means for modifying the intensity distribution and FIG. 3b shows a transmission profile of the means for modifying the intensity distribution;

FIGS. 4a and 4c show intensity distributions of the first radiation beam before and after the means for modifying the intensity distribution and FIG. 4b shows a transmission profile of said means for modifying the intensity distribution, in another preferred embodiment of the invention.

FIG. 5 shows relative optical throughputs of the first and second radiation beams as a function of the coupling numerical aperture of the first radiation beam;

FIG. 6 is a cross section of an optical component in accordance with an advantageous embodiment of the invention;

FIGS. 7a to 7d are top views of the optical component of FIG. 6;

FIG. 8 is a cross section of an optical component in another preferred embodiment of the invention.

### DETAILED DESCRIPTION OF THE INVENTION

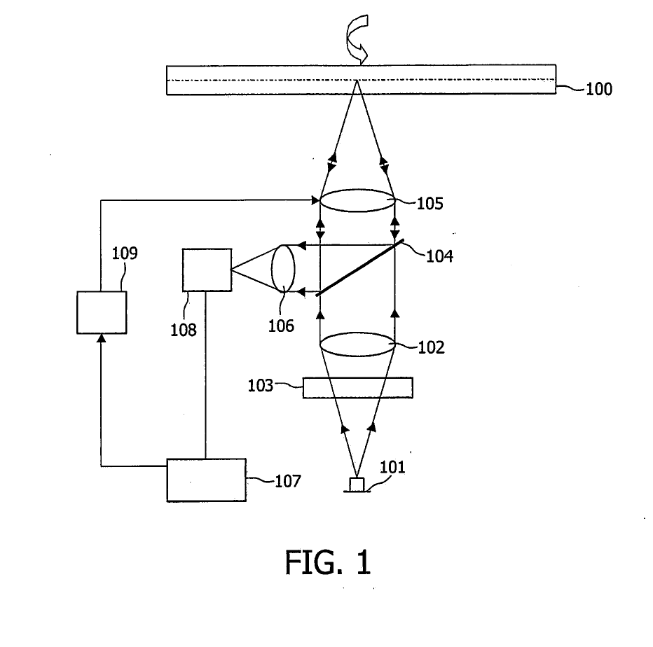

An optical device according to the invention is depicted in FIG. 1. Such an optical device comprises a radiation source 101 for producing a first and a second radiation beam, a collimator 102, an optical component 103, a beam splitter 104, an objective lens 105, a servo lens 106, detecting means 107, measuring means 108, and a controller 109. This optical device is intended for scanning an information carrier 100.

During a scanning operation, which may be a writing operation or a reading operation, the information carrier 100 is scanned by either the first or the second radiation beam produced by the radiation source 101. The optical scanning device further comprises means for detecting the type of information carrier scanned. If the information carrier is of a first type, the first radiation beam is generated by the radiation source 101. If the information carrier is of a second type, the second radiation beam is generated by the radiation source 101. The first radiation beam is generated by a first radiation source and the second radiation beam is generated by a second radiation source. In the example of FIG. 1, the first and second radiation source form part of the radiation source 101. Hence, the first and second radiation source may be two different radiation sources that generate two different radiation beams, or may be only one radiation source which can generate at least two different radiation beams, for example a wavelength tunable diode laser.

The first and second radiation beams are directed on a common optical path. In the example of FIG. 1, the first and second radiation beams are already on the same optical path, because they are generated by the same radiation source 101. If the first and the second radiation beams are generated by two different radiation sources, the optical scanning device comprises means for directing the first and the second radiation beam on a common optical path. For example, the optical scanning device comprises a mirror, a beam splitter and a reflector as shown in FIG. 1 of patent application WO02/25646.

The collimator 102 and the objective lens 105 focus the selected radiation beam on an information layer of the information carrier 100. During a scanning operation, a focus error signal may be detected, corresponding to an error of positioning of the selected radiation beam on the information layer. This focus error signal may be used for correcting the axial position of the objective lens 105, so as to compensate for a focus error of the selected radiation beam. A signal is sent to the controller 109, which drives an actuator in order to move the objective lens 105 axially.

The focus error signal and the data written on the information layer are detected by the detecting means 107. The selected radiation beam, reflected by the information carrier 100, is transformed into a parallel beam by the objective lens 105, and then reaches the servo lens 106, thanks to the beam splitter 104. This reflected beam then reaches the detecting means 107.

The optical component 103 is designed for transmitting only a certain percentage of the intensity of the first radiation beam when the first radiation beam is selected, while transmitting all the intensity of the second radiation beam when the second radiation beam is selected. Examples of the optical component 103 are given in the following Figs. According to the invention, the optical component 103 transmits a relatively high percentage of the intensity of the portion of the first radiation beam located near the outer envelope of the first radiation beam and a relatively low percentage of the intensity of the portion of the first radiation beam located near the central axis of the first radiation beam.

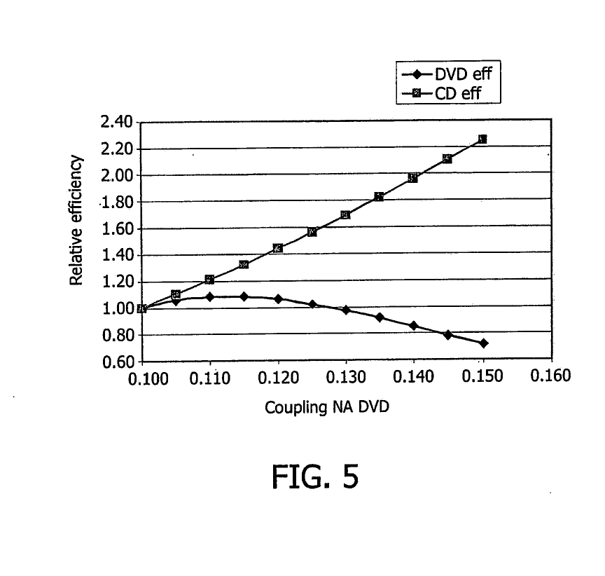

As a consequence, the rim intensity of the first radiation beam after the optical component 103 is increased by means of the optical component 103. It is thus possible to increase the numerical aperture of the collimator 102 without affecting the rim intensity of the first radiation beam, because the decrease of the rim intensity due to the increase of the numerical aperture of the collimator 102 can be compensated by the use of the optical component 103. Moreover, the optical throughput of the first radiation beam is only slightly affected. Actually, the optical throughput is, on one hand, reduced because the intensity of the first radiation beam is globally reduced by means of the optical component 103. On the other hand, the increase of the numerical aperture of the collimator 102 increases the optical throughput of the first radiation beam. The variation of the optical throughput of the first radiation beam with respect to the numerical aperture of the collimator 102, when keeping the rim intensity of the first radiation beam constant, is shown in FIG. 5.

Furthermore, the increase of the numerical aperture of the collimator 102 increases the optical throughput of the second radiation beam. As the optical component 103 acts as a transparent plate for the second radiation beam, the optical component does not modify the intensity of the second radiation beam. The optical throughput may thus be strongly increased, as will be explained in more detail in FIG. 5.

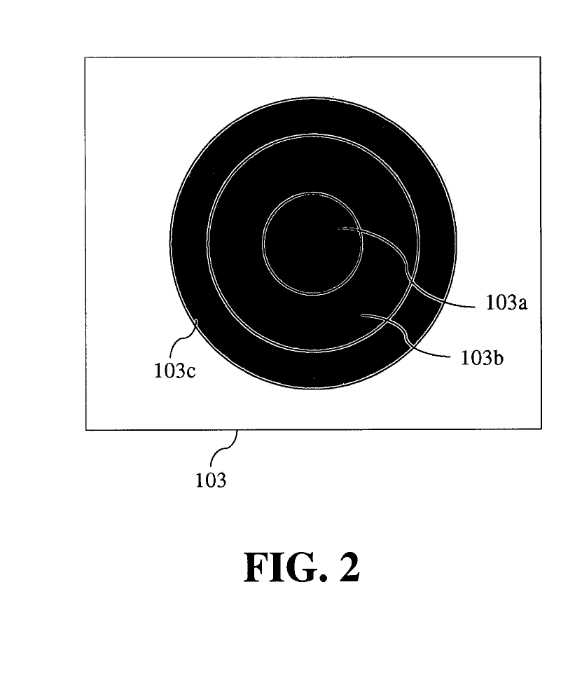

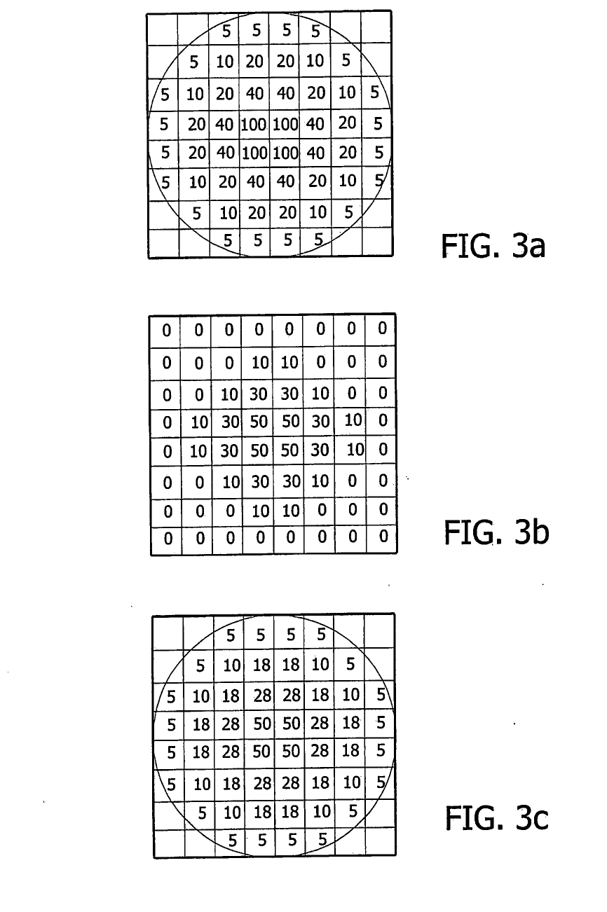

An example of optical component 103 that can be used in the optical scanning device of FIG. 1 is shown in FIG. 2. FIG. 2 shows a top view of such an optical component. The optical component 103 comprises a first reflective part 103a, a second reflective part 103b and a third reflective part 103c. Each reflective part comprises a dichroic coating. A reflective dichroic coating is a coating which reflectivity depends on the wavelength of the radiation beam passing through said coating. In the example of FIG. 3, the reflective coatings of the three reflective parts 103a to 103c are chosen to be reflective at the wavelength of the first radiation beam, while being fully transparent at the wavelength of the second radiation beam. Such dichroic coatings are well known to those skilled in the art. For example, they are used on objective lenses compatible with two different radiation beams having different numerical apertures, where an annular exterior portion of the objective lens is coated with such a dichroic coating. The three dichroic coatings form a dichroic filter on the optical component 103.

In the example of FIG. 2, the first reflective part 103a, which is located near the central axis of the first radiation beam when the optical component is placed on the common optical path, is more reflective than the second reflective part 103b, which is more reflective than the third reflective part 103c located near the outer envelope of the first radiation beam when the optical component is placed on the common optical path. As a consequence, the ratio between the intensity near the envelope and the intensity near the central axis of the first radiation beam is reduced.

Although the optical component of FIG. 3 only comprises three coated parts, it may comprise more coated parts. The dichroic filter may be coated by means of vapour deposition, for example by means of a mask. Hence, the dichroic filter may be formed, for example, in a pixel wise manner. Examples of transmission profiles of the optical component 103 are given in the following Figs.

FIG. 3a shows the intensity distribution of the first radiation beam before passing through the means for modifying the intensity distribution. In this Fig., the numbers represent the intensities of the first radiation beam in each portion of a section through the first radiation beam. An arbitrary scale is chosen, from 0 to 100, to describe the intensities of the first radiation beam.

In this example, the first radiation beam is circularly shaped, which means that the intensity distribution is uniform in all directions starting from the central axis to the outer envelope of the first radiation beam. The outer envelope is schematically represented by a circle, and the intensities of the first radiation beam are schematically represented by numbers between 5 and 100. Of course, the intensity distribution of the first radiation beam is continuous, although it is represented as discontinuous for convenience reasons.

The portion of the first radiation beam near the central axis corresponds to the portions having an intensity equal to 100, and the portion of the first radiation beam near the outer envelope corresponds to the portions having an intensity equal to 5. Of course, the portion near the central axis and the portion near the outer envelope may be defined differently. For example, the portion near the central axis may be defined as a circular area having a first radius. The portion near the outer envelope may be defined as an annular area having a second inner radius and a third outer radius. The portion near the central axis may also correspond to the portions of the first radiation beam having an intensity higher than a certain percentage of the maximum intensity of the first radiation beam, and the portion near the outer envelope may correspond to the rest of the radiation beam. Whatever the definition of the portion near the central axis and the portion near the outer envelope, the invention can be implemented, as soon as the portion near the outer envelope is at a greater distance from the central axis than the portion near the central axis.

In this example, with the definition of the portion near the central axis and the portion near the outer envelope given above, the rim intensity is 5 percent of the intensity of the portion near the central axis.

In order to increase this rim intensity, means for modifying the intensity distribution are used, which are described in FIG. 3b. FIG. 3b shows the transmission profile of the means for modifying the intensity distribution. These means for modifying the intensity distribution are, for example, the optical component 103 of FIG. 2.

In this example, the means for modifying the intensity distribution comprise pixels, each pixel having a reflectivity between 0 and 50, on an arbitrary scale. Hence, the transmission profile of the means for modifying the intensity distribution is discontinuous. However, it is obvious that means for modifying the intensity distribution having a continuous transmission profile may be used, without departing from the scope of the invention.

When a portion of the first radiation beam is transmitted through a portion of the means for modifying the intensity distribution having a relatively high reflectivity, the intensity of this portion of the first radiation beam is relatively strongly reduced. When a portion of the first radiation beam is transmitted through a portion of the means for modifying the intensity distribution having a lower reflectivity, the intensity of this portion of the first radiation beam is less strongly reduced. As a consequence, a particular reflectivity of the means for modifying the intensity distribution will correspond to the percentage of the intensity of the portion of the first radiation beam which is not transmitted, when said portion of the first radiation beam is transmitted through the portion of the means for modifying the intensity distribution having this reflectivity. In FIG. 3b, as an arbitrary scale has been chosen for the reflectivity, this reflectivity also corresponds to the percentages of the non-transmitted intensities. Hence, FIG. 3b corresponds to a “reflection profile”, from which the transmission profile can easily be deduced.

In this example, the means for modifying the intensity distribution are designed for leaving unchanged the intensity of the portion of the first radiation beam located near the outer envelope, and for reducing the intensity of the portion of the first radiation beam located near the central axis.

When the first radiation beam having the intensity distribution of FIG. 3a is transmitted through the means for modifying the intensity distribution having the transmission profile of FIG. 3b, a radiation beam having the intensity distribution of FIG. 3c is obtained.

The intensity of the portion near the central axis is reduced by 50 percent after passing through the means for modifying the intensity distribution, whereas the intensity of the portion near the outer envelope is unchanged. As a consequence, the rim intensity is increased. In this example, the rim intensity beyond the means for modifying the intensity distribution is 10 percent of the intensity of the portion near the central axis.

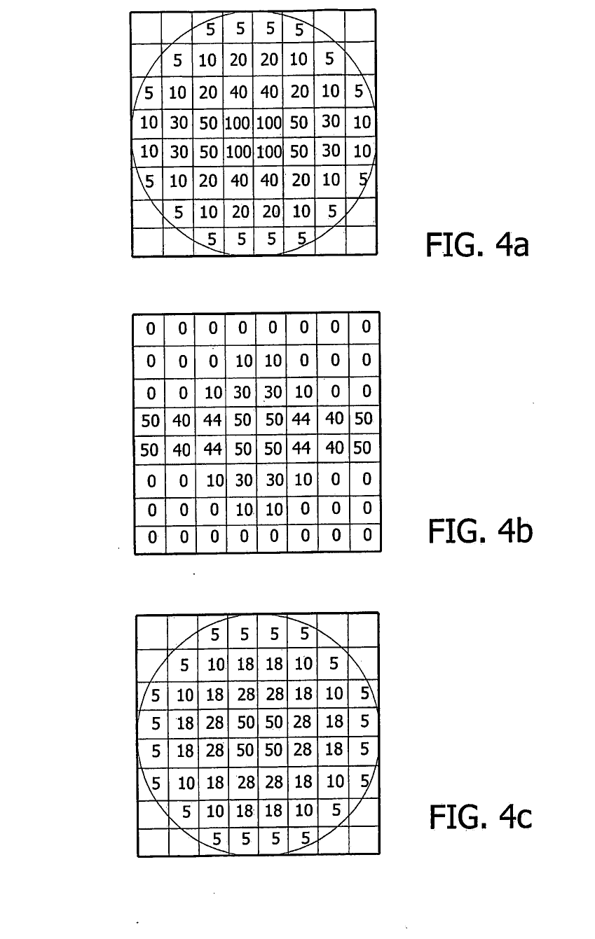

FIG. 4a shows the intensity distribution of the first radiation beam before the means for modifying the intensity distribution, for a radiation source having a divergence aspect ratio greater than 1.

In this example, the first radiation beam comprises a first intensity distribution with a first mean intensity in a first direction and a second intensity distribution with a second mean intensity in a second direction perpendicular to the first direction. The first direction corresponds to the portions having intensities equal to 100, 40, 20 and 5, the second direction corresponds to the portions having intensities equal to 100, 50, 30 and 10. Hence, the second mean intensity is greater than the first mean intensity. This corresponds to an elliptically shaped beam, which leads to artefacts during writing and reading.

In order to remedy this drawback, the means for modifying the intensity distribution are designed for reducing the second mean intensity more strongly than the first mean intensity. FIG. 4b shows the transmission profile of the means for modifying the intensity distribution. The reflectivity of the pixels of the means for modifying the intensity distribution is higher in the second direction than in the first direction.

When the first radiation beam having the intensity distribution of FIG. 4a is transmitted through the means for modifying the intensity distribution having the transmission profile of FIG. 4b, a radiation beam having the intensity distribution of FIG. 4c is obtained. In FIG. 4c, the intensity distributions of the radiation beam are the same in the first and second direction, which leads to a circularly shaped radiation beam. Moreover, the rim intensity is increased by the means for modifying the intensity distribution having the transmission profile of FIG. 4b. Actually, the rim intensity for the radiation beam having the intensity distribution of FIG. 4c is 10 percent of the intensity of the part near the central axis, whereas the rim intensity for the first radiation beam having the intensity distribution of FIG. 4a is 6 percent of the intensity of the part near the central axis.

FIG. 5 shows the coupling efficiencies of the first and the second radiation beam, when the coupling numerical aperture of the first radiation beam is modified while keeping the rim intensity of the first radiation beam constant. As explained hereinbefore, it is possible to increase the numerical aperture of the collimator 102, and thus the coupling numerical aperture of the first radiation beam, while keeping the rim intensity of the first radiation beam constant, by means of the optical component 103. In the example of FIG. 5, the first radiation beam is a DVD radiation beam and the second radiation beam is a CD radiation beam. The Y-axis represents a relative coupling efficiency, i.e. the ratio between the coupling efficiency when the invention is implemented and the coupling efficiency when the invention is not implemented. In the latter case, the coupling numerical aperture of the first radiation beam is 0.1.

The coupling efficiency of the DVD radiation beam is only slightly modified when the coupling numerical aperture is increased, whereas the coupling efficiency of the CD radiation beam is strongly increased. For example, if one takes the value 0.130 for the coupling numerical aperture, the coupling efficiency of the DVD radiation beam is not modified, while the coupling efficiency of the CD radiation beam is increased by 70 percent. FIG. 5 thus illustrates that it is possible to relatively strongly increase the coupling efficiency of the second radiation beam while not decreasing the rim intensity of the first radiation beam.

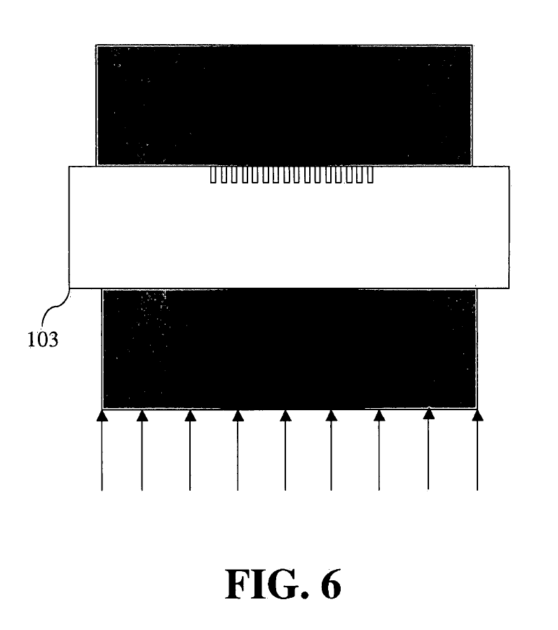

FIG. 6 shows another example of optical component 103. In this example, the optical component 103 comprises a phase structure located around the central axis of the first radiation beam. The portion of the first radiation beam that passes through said phase structure is diffracted, whereas the portion of the first radiation beam that does not pass through said phase structure is completely transmitted by the optical component 103. FIG. 6 shows the intensity distribution of the first radiation beam before and beyond the optical component 103. Thanks to the phase structure, the intensity near the central axis of the first radiation beam is reduced, whereas the intensity near the outer envelope remains unchanged. As a consequence, the rim intensity is increased.

In the example of FIG. 6, the phase structure is periodic. As a consequence, the portion of the first radiation beam located near the central axis of said first radiation beam is diffracted in predominantly three orders of diffraction. The 0^{th} order is represented in FIG. 6. The two other orders of diffraction give rise to two spots that are consequently focused on the information carrier 100. These two additional spots that are created by means of the optical component 103 can be used for tracking, using the well-known 3 spots or differential push-pull tracking method. As a consequence, the light that is removed from the first radiation beam in order to increase the rim intensity is used for tracking, which means that no light is lost in the optical scanning device, hence increasing the optical throughput.

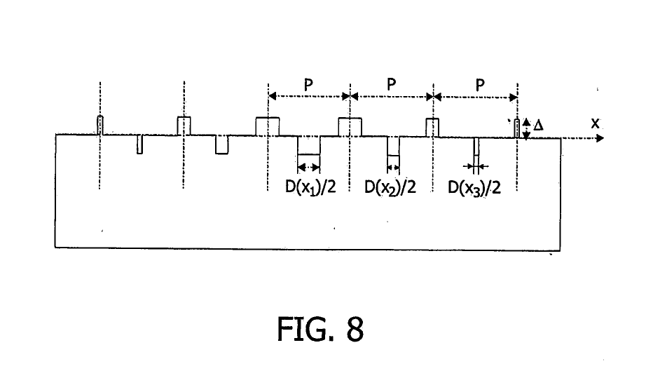

The optical component should diffract the first radiation beam and should act as a transparent plate for the second radiation beam. This can be achieved in that the phase depth of the diffractive structure is a multiple of 2π for the wavelength of the second radiation beam and is not a multiple of 2π for the wavelength of the first radiation beam. This is explained in more detail in FIG. 8.

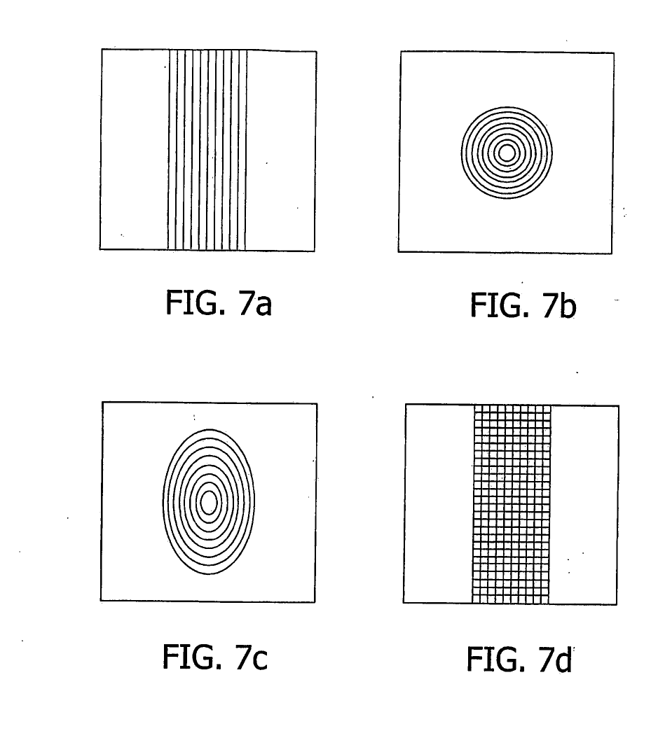

FIGS. 7a to 7d show possible top views of the optical component 103, which cross section is represented in FIG. 6. In the example of FIG. 7a, the optical component 103 comprises a conventional grating that diffracts light in only one dimension. Such an optical component is well adapted for a first radiation beam having an intensity distribution that varies according to one preferred direction, which is perpendicular to the tracks represented in FIG. 7a.

In the example of FIG. 7b, the optical component 103 comprises a circular grating that diffracts light in two dimensions. Such an optical component is well adapted for a first radiation beam having a circularly distributed intensity.

In the example of FIG. 7c, the optical component 103 comprises an elliptical grating that diffracts light in two dimensions. Such an optical component is well adapted for a first radiation beam having an elliptically distributed intensity.

In the example of FIG. 7d, the optical component 103 comprises a grating with a checkerboard like phase structure that diffracts light in two dimensions.

FIG. 8 is a cross section of an optical component in a preferred embodiment of the invention. Such an optical component has a phase structure with a duty cycle which decreases from the central axis to the outer envelope of the first radiation beam when the optical component is placed in the common optical path. The duty cycle is defined as D(x)/P, where P is the period of the phase structure and D(x) is the quantity represented in FIG. 8. The transmission of the optical component of FIG. 8 is given by the expression:

T(x)=1−D(x)(1−cos²δ)/P, where δ is the phase depth defined by δ=(n−1)Δπ/λ, where n is the index of refraction of the optical component, λ the wavelength of the radiation beam passing through said optical component and Δ the mechanical depth of the phase structure.

It is possible to design the mechanical depth Δ in such a way that the phase depth δ is a multiple of 2π for the wavelength of the second radiation beam and is not a multiple of 2π for the wavelength of the first radiation beam. In this case, the transmission of the optical component is constant and equal to 1 for the second radiation beam, which means that the optical component acts as a transparent plate for the second radiation beam.

As the duty cycle decreases from the central axis to the outer envelope of the first radiation beam, the transmission of the optical component increases. The optical component of FIG. 8 is particularly advantageous, because it does not introduce wavefront aberrations in the diffracted and un-diffracted beams. Actually, the phase depth δ of the phase structure is constant. The phase structure of the optical component of FIG. 8 is periodic, which means that this optical component can also be used for creating the two satellite spots used for the 3 spots push-pull tracking method.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An optical device comprising a first radiation source (101) for producing a first radiation beam, a second radiation source (101) for providing a second radiation beam and a radiation director arranged to direct the first and second radiation beams along a common optical path, each radiation beam having an intensity distribution, a central axis and an outer envelope, the optical device further comprising, in the common optical path, an intensity distribution modifier (103) for modifying the intensity distribution of the first radiation beam only, which is designed for increasing the ratio between the intensity near the envelope and the intensity near the central axis of the first radiation beam by reducing at least the intensity of the first radiation beam near its central axis.

2. An optical device is claimed in claim 1, wherein the first and second radiation sources form part of one and the same laser diode (101).

3. An optical device as claimed in claim 1, wherein the first radiation beam comprises at least a first and a second direction perpendicular to its central axis, the first radiation beam having a first intensity distribution with a first mean intensity in the first direction and a second intensity distribution with a second mean intensity in the second direction, said second mean intensity being greater than the first mean intensity, wherein the intensity distribution modifier is designed for reducing the second mean intensity more strongly than the first mean intensity.

4. An optical device as claimed in claim 1, wherein the intensity distribution modifier comprises an optical component designed for increasing the ratio between the intensity near the envelope and the intensity near the central axis of the first radiation beam in that the first radiation beam is diffracted at least near the central axis.

5. An optical device as claimed in claim 4, wherein the optical component has a phase structure with a duty cycle which decreases from the central axis to the outer envelope of the radiation beam.

6. An optical device as claimed in claim 4, wherein the optical component has a periodic phase structure.

7. An optical device as claimed in claim 1, wherein the intensity distribution modifier comprises a dichroic filter (103a, 103b, 103c).

8. An optical component for modifying the intensity distribution of a first radiation beam having a first wavelength while not modifying the intensity distribution of a second radiation beam having a second, different wavelength, said optical component being designed for increasing the ratio between the intensity near the envelope and the intensity near the central axis of the first radiation beam by reducing at least the intensity of the first radiation beam near its central axis.

9. An optical component as claimed in claim 8, said optical component being designed for increasing the ratio between the intensity near the envelope and the intensity near the central axis of the first radiation beam in that the first radiation beam is diffracted at least near the central axis.

10. An optical component as claimed in claim 8, said optical component comprising a dichroic filter.
